(19) United States
(12) Patent Application Publication
(10) Pub. No.: US 2026/0126019 A1
(43) Pub. Date: May 7, 2026

(54) GASEOUS FUEL SYSTEMS AND CONTROLS

(71) Applicant: Cummins Inc., Columbus, IN (US)

(72) Inventors: Donald J. Benson, Columbus, IN (US); Ahmad M. Sabri, Columbus, IN (US)

(21) Appl. No.: 19/119,929

(22) PCT Filed: Oct. 5, 2023
(86) PCT No.: PCT/US23/76032

§ 371 Date: Apr. 10, 2025

Related U.S. Application Data
(60) Provisional application No. 63/380,813, filed on Oct. 25, 2022.

(51) Int. Cl. F02D 41/38; F02D 41/00; F02D 41/30

(52) U.S. Cl. CPC F02D 41/38; F02D 41/0027; F02D 41/3094; F02D 2200/0602; F02D 2200/0606; F02D 2200/0616; F02D 2200/101

(57) ABSTRACT

A gaseous fueling system includes a fuel rail in fluid communication with an injector and a combustion chamber in fluid communication with the injector. An electronic controller opiates the injector perform an injection of gaseous fuel to the combustion chamber, obtaining a pressure measurement indicating a pressure of gaseous fuel in the rail during the operating, determines a upper value of the pressure measurement and a lower value of the pressure measurement, calculates a difference between the upper value of the pressure measurement and the lower value of the pressure measurement, calculates an injected fuel quantity estimate using the difference, and operates the gaseous fueling system using the injected fuel quantity estimate.

### CROSS-REFERENCE

The present application claims priority to and the benefit of U.S. Application No. 63/380,813 filed Oct. 25, 2022, and the same is hereby incorporated by reference.

### TECHNICAL FIELD

The present application relates to gaseous fueling systems and related apparatuses, controls, diagnostic, processes, systems, and techniques.

### BACKGROUND

Gaseous fueling systems for internal combustion engines and controls for such systems suffer from a number of shortcomings including those respecting accuracy, complexity, computational burden, dedicated hardware requirements, precision, reliability, and robustness, among other shortcomings. There remains a significant need for the unique apparatuses, processes, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include unique gaseous fueling system controls. Further embodiments include unique apparatuses, systems, and processes comprising or embodying such controls. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example engine system including an example fueling system.

FIG. 2 is a schematic diagram illustrating certain aspects of an example fueling system.

FIG. 3 is a flow diagram illustrating certain aspects of an example process.

FIG. 4 is a schematic diagram illustrating certain aspects of example controls.

FIG. 5 is a flow diagram illustrating certain aspects of an example process.

FIG. 6 is a graph illustrating certain aspects of an example control process and example controls.

FIG. 7 is a set of graphs illustrating certain aspects of an example control process and example controls.

### DETAILED DESCRIPTION OF EXAMPLE EMBODIMENTS

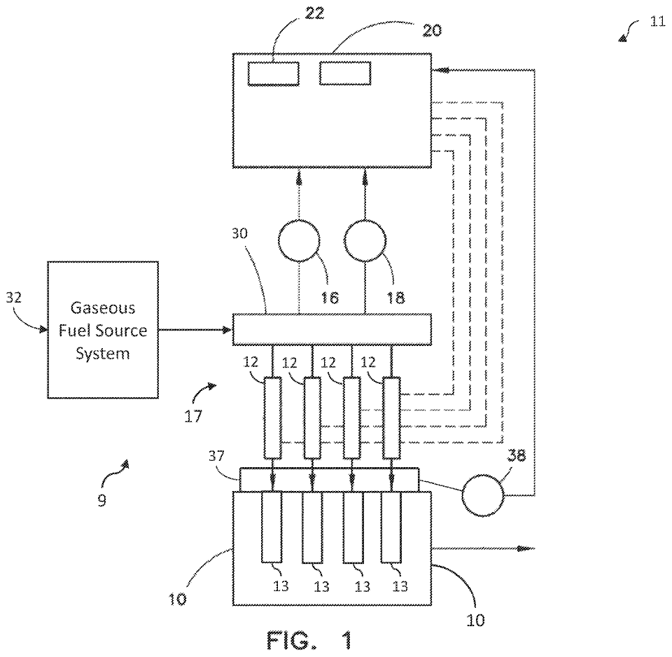

With reference to FIG. 1, there is illustrated a system 11 comprising an engine 10 and a gaseous fueling system 9. Gaseous fueling system 9 is configured to supply a gaseous fuel, such as such as natural gas, hydrogen, bio-derived gaseous fuels, hydrogen, mixed gases fuels or other gaseous fuels for combustion by engine 10. Engine 10 comprises combustion chambers 13 (also referred to as cylinders) of a reciprocating piston-in-cylinder-type engine which are configured to generate mechanical power from the combustion of gaseous fuel supplied by fuel injectors 12. Fuel injectors 12 are in fluid communication with respective combustion chambers 13 of the engine 10 and are structured to inject gaseous fuel which is provided to their respective combustion chambers 13. In the illustrated embodiment, fuel injectors 12 are configured and provided as port fuel injectors configured to inject fuel directly into respective ports of intake manifold 37 leading to respective combustion chambers 13 of engine 10. Other embodiments may include other types and configurations of injectors such as direct fuel injectors configured to inject fuel directly into respective combustion chambers 13 of engine 10. In the illustrated embodiment, four fuel injectors 12 and four combustion chambers 13 are depicted, it being appreciated that engine 10 may include fewer or greater numbers of fuel injectors 12 and combustion chambers 13. System 11 may be provided in a number of forms including as a prime mover system (or component of a prime mover system) of vehicle, a genset, other power-load system.

In the illustrated embodiment, the gaseous fueling system 9 includes a gaseous fuel supply and injection system 17 and a gaseous fuel source system 32. Gaseous fuel supply and injection system 17 includes one or more rails 30 and one or more sets of injectors 12 operatively coupled with and supplied with gaseous fuel from a respective one of the one or more rails 30. The one or more rails 30 are, in turn, configured to receive pressurized fuel from gaseous fuel source system 32.

The gaseous fuel source system 32 may include a high pressure tank configured to store a supply of gaseous fuel at high pressure. In some embodiments, gaseous fuel source system 32 may include additional elements such as a compressor configured to compress gaseous fuel received from the fuel tank supply compressed gaseous fuel to the one or more rails 30, and/or and accumulator as well as electronically controllable valves configured to control supply of gaseous fuel to and from the accumulator and/or the one or more rails 30.

It shall be appreciated that the illustrated form of gaseous fueling system 9 is but one example of a fueling system according to the present disclosure. In other embodiments, the gaseous fueling system 9 may be configured and provided as another type of gaseous fueling system, for example, as a gaseous hydrogen fueling system. In other embodiments, gaseous fueling system 9 may be configured and provided in other forms, for example, as a high-pressure common-rail diesel fuel injection system or other types of fueling systems.

System 11 further includes electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 typically include at least one electronic control unit (ECU) 22 configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the system 11. For example, the sensors may include one or more pressure sensors 16 and one or more temperature sensors 18. The one or more pressure sensors 16 are in communication with the one or more rails 30 and structured to communicate a measurement of the pressure of gaseous fuel in the one or more rails 30 (also referred to as fuel rail pressure or rail pressure) to the ECS 20. The one or more temperature sensors 18 are in communication with the one or more rails 30 and structured to communicate a measurement of the temperature of gaseous fuel in the one or more rails 30 (also referred to as fuel rail temperature or rail temperature) to the ECS 20. System 11 include an intake manifold pressure (IMP) sensor 38 in communication with and configured to sense a pressure of intake manifold 37.

As will be appreciated by the description that follows, the techniques described herein relating to fuel injector or fuel injection parameters can be implemented in ECS 20, which may include one or more controllers for controlling different aspects of the system 11. In certain embodiments, the ECS 20 comprises one or more electronic control units (ECU) such as an engine control unit or engine control module. The ECS 20 may be comprised of digital circuitry, analog circuitry, or a hybrid combination of both of these types. Also, the ECS 20 may be programmable, an integrated state machine, or a hybrid combination thereof. The ECS 20 may include one or more Arithmetic Logic Units (ALUs), Central Processing Units (CPUs), memories, limiters, conditioners, filters, format converters, or the like which are not shown to preserve clarity. In one form, the ECS 20 is of a programmable variety that executes algorithms and processes data in accordance with operating logic that is defined by programming instructions (such as software or firmware). Alternatively or additionally, operating logic for the ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 11. As used herein, the term sensors may include any suitable hardware and/or software used to sense or estimate any engine system parameter and/or various combinations of such parameters either directly or indirectly.

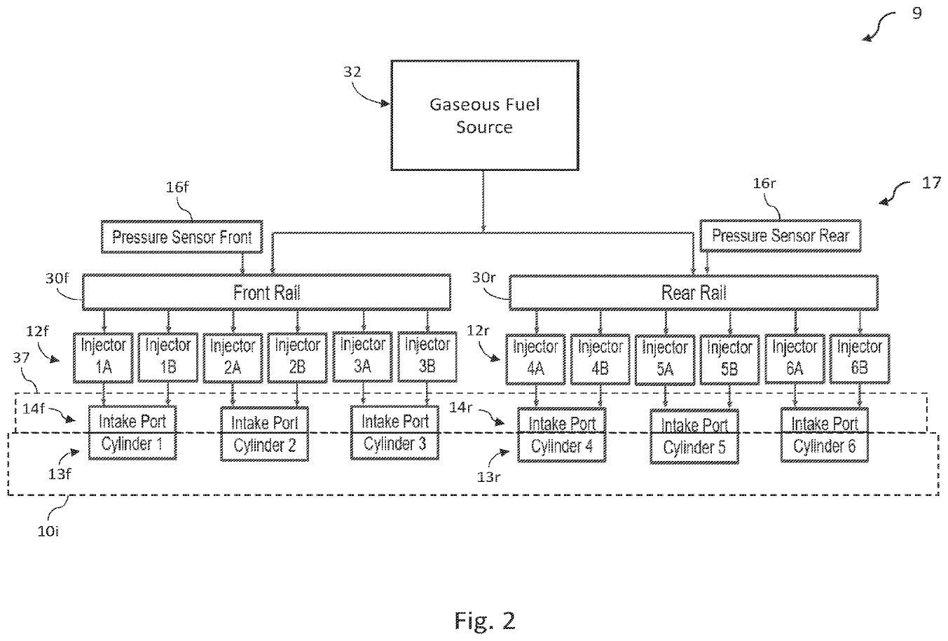

With reference to FIG. 2, there are illustrated further details of an example embodiment of gaseous fueling system 9. In the illustrated example of gaseous fueling system 9, gaseous fuel source system 32 is configured to supply pressurized gaseous fuel to front rail 30f and rear rail 30r. Front rail 30f and rear rail 30r are configured and provided as physically separated or divided gaseous fuel containment structures which may be provided in a number of forms including, for example, as physically separated or divided tubular fuel rails or pipes or physically separated or divided bores formed in an engine component such as an intake manifold or cylinder head. Front rail 30f and rear rail 30r preferably are supplied with pressurized gaseous fuel from gaseous fuel source system 32 at separate and distinct locations effective to provide a degree of isolation between their respective pressures.

Front rail 30f is configured and operable to supply pressurized gaseous fuel to a front plurality of injectors 12f which are configured to inject gaseous fuel to particular ones of a plurality of front cylinder intake ports 14f associated with a first plurality of cylinders 13f. In the illustrated example, the first plurality of cylinders 13f comprises the first, second, and third cylinders formed in a block of an in-line six-cylinder engine 10i. In the illustrated example, front plurality of injectors 12f comprises injectors 1A, 1B, 2A, 2B, 3A, and 3B. Injectors 1A and 1B are configured to supply gaseous fuel to a first intake port of intake manifold 37 leading to a first combustion cylinder. Injectors 2A and 2B are configured to supply gaseous fuel to a second intake port of intake manifold 37 leading to a second combustion cylinder. Injectors 3A and 3B are configured to supply gaseous fuel to a third intake port of intake manifold 37 leading to a third combustion cylinder.

Rear rail 30r is configured and operable to supply pressurized gaseous fuel to a rear plurality of injectors 12r which are configured to inject gaseous fuel to particular ones of a plurality of rear cylinder intake ports 14r associated with a second plurality of cylinders 13r. In the illustrated example, the second plurality of cylinders 13r comprises the fourth, fifth, and sixth cylinders formed in a block of an in-line six-cylinder engine 10i. In the illustrated example, rear plurality of injectors 12r comprises injectors 4A, 4B, 5A, 5B, 6A, and 6B. Injectors 4A and 4B are configured to supply gaseous fuel to a fourth intake port of intake manifold 37 leading to a fourth combustion cylinder. Injectors 5A and 5B are configured to supply gaseous fuel to a fifth intake port of intake manifold 37 leading to a fifth combustion cylinder. Injectors 6A and 6B are configured to supply gaseous fuel to a sixth intake port of intake manifold 37 leading to a sixth combustion cylinder.

It shall be appreciated that front rail 30f and rear rail 30r are one example of a form in which the one or more rails 30 illustrated and described in connection with FIG. 1 comprise a first rail and a second rail separated or divided from the first rail. Other embodiments in which the one or more rails 30 comprise a first rail and a second rail separated or divided from the first rail are also contemplated. Such embodiments include, for example, systems comprising relative arrangements and positionings of multiple fuel rails servicing a set of in-line cylinders other than front and rear, systems wherein the one or more rails 30 comprise three or more rails, and/or systems wherein the one or more rails 30 comprise two or more rails configured to supply gaseous fuel to the same set or group of cylinders. Likewise, while the illustrated example pertains to an engine including six cylinders, other embodiments relate to other engines including more or less than six cylinders.

As illustrated by the embodiment of FIG. 2, first plurality of cylinders 13f and second plurality of cylinders 13r provide an example of a first subset of a plurality of cylinders arranged in an in-line configuration a second subset of the plurality of cylinders, wherein the first subset and the second subset have a predetermined firing order.

The illustrated embodiment provides an example in which the first plurality of cylinders 13f and the second plurality of cylinders 13r are configured such that a firing order of the plurality of cylinders alternates between the first plurality of cylinders 13f and the second plurality of cylinders 13r. It shall be appreciated that the firing order of the plurality of cylinders may be predetermined or established by the physical construction of the engine and the relative positioning of a connection of each of the plurality of cylinders with a common crankshaft and may be further supported by an electronic control system controlling ignition (e.g., by firing a spark plug or performing a pilot injection in the form of a liquid spark) according to the predetermined or established firing order.

The illustrated embodiment also provides an example in which the first plurality of cylinders 13f and the second plurality of cylinders 13r are configured such that the first plurality of cylinders 13f and the second plurality of cylinders 13r are selected and configured such that none of the first plurality of cylinders 13f is adjacent in firing order to another of the first plurality of cylinders 13f, and none of the second plurality of cylinders 13r is adjacent in firing order to another of the second plurality of cylinders 13r.

The illustrated embodiment also provides an example in which the first plurality of cylinders 13f and the second plurality of cylinders 13r are arranged in an in-line, six-cylinder configuration in an order including a cylinder number one, a cylinder number two, a cylinder number three, a cylinder number four, a cylinder number five, and a cylinder number six, wherein the firing order of the plurality of cylinders is cylinder number one followed by cylinder number five, followed by cylinder number three, followed by cylinder number six, followed by cylinder number two, followed by cylinder number four.

The illustrated embodiment also provides an example in which a first plurality of gaseous fuel injectors (e.g., injectors 12f) comprise a first plurality of first pairs of gaseous fuel injectors each configured to supply fuel to a respective one of a first set of cylinders (e.g., cylinders 13f), and a second plurality of gaseous fuel injectors (e.g., injectors 12r) comprise a second plurality of second pairs of gaseous fuel injectors each configured to supply fuel to a respective one of a second set of cylinders (e.g., cylinders 13r).

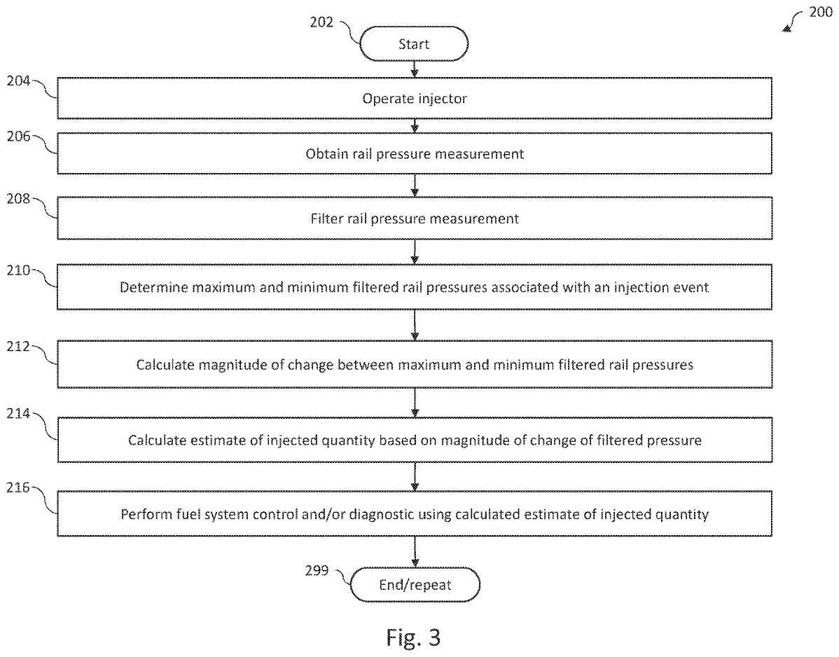

With reference to FIG. 3, there is illustrated an example process 200 for operating an electronic control system (e.g., ECS 20 or another electronic control system), in operative communication with a fueling system (e.g., gaseous fueling system 9 or another fueling system). Process 200 may be implemented in and performed by one or more components of an electronic control system such as one or more electronic control units (e.g., ECU 22 and/or other electronic control units) and/or by other electronic control system components.

Process 200 begins at start operation 202 and proceeds to operation 204 which operates a gaseous fuel injector to perform an injection of gaseous fuel to a combustion chamber. Operation may operate a gaseous fuel injector to inject gaseous fuel to a combustion chamber via an intake port of intake manifold whereby gaseous fuel injected into the intake port is provided to a combustion chamber in fluid communication with the intake port.

From operation 204, process 200 proceeds to operation 206 which obtains a pressure measurement of gaseous fuel in the rail during the operation 204 (also referred to as a rail pressure measurement). Operation 206 may obtain a rail pressure measurement by repeatedly sampling a signal received from a pressure sensor during operation of an injector to perform an operation (e.g., from a time at or prior to a start of injection to a time at or after an end of injection). The pressure sensor may be in operative communication directly with the fuel rail and operable to sense a pressure of gaseous fuel in the fuel rail. The pressure sensor may additionally or alternatively be in operative communication with and configured to sense gaseous fuel pressure of other locations of a gaseous fuel system which are correlated with or from which a pressure of gaseous fuel in the fuel rail can be determined.

From operation 206, process 200 proceeds to operation 208 which filters the rail pressure measurement. Operation 208 may filter the rail pressure measurement using a technique such as a moving average filter to improve the accuracy, precision, and signal-to-noise ratio of the rail pressure measurement. In some embodiments or some instances of execution of process 200, operation 208 may be omitted and an unfiltered or raw rail pressure measurement may be utilized by subsequent operations of process 200.

From operation 208, process 200 proceeds to operation 210 which determines an upper value and a lower value of the rail pressure measurement which, as noted above, may have been filtered at operation 208 or may be raw or unfiltered. Operation 210 may determine the upper value and lower value of the rail pressure measurement in a number of manners. In some embodiments or some instances of execution of process 200, operation 210 may determine the upper value as the maximum or greatest value of a rail pressure measurement including a plurality of measurement points and/or may determine the lower value as the minimum or smallest value of a rail pressure measurement including a plurality of measurement points. In some embodiments or some instances of execution of process 200, operation 210 may determine the upper value as a value proximate the maximum or greatest value of a rail pressure or as an average or combination of multiple measurement points proximate or following the maximum or greatest value and/or may determine the lower value as a value proximate the minimum or lowest value of a rail pressure or as an average or combination of multiple measurement points proximate or preceding the minimum or lowest value.

From operation 210, process 200 proceeds to operation 212 which calculates a difference (e.g., a magnitude of change) between the upper value of the rail pressure measurement and the lower value of the rail pressure measurement.

From operation 212, process 200 proceeds to operation 214 which calculates an injected fuel quantity estimate using the difference calculated as operation 212. Operation 214 may also use an engine speed and a temperature of gaseous fuel in the rail during the operating in calculating an injected fuel quantity estimate.

From operation 214, process 200 proceeds to operation 216 which operates the gaseous fueling system using the injected fuel quantity estimate. Operation 216 may comprise a number of operations. In some embodiments, operation of gaseous fueling system using the injected fuel quantity estimate may include balancing operation of the gaseous fuel injector with operation of a second gaseous fuel injector of the gaseous fueling system. Such balancing may include, for example, adjusting a subsequent operation of one or more gaseous fuel injectors by an adjustment factor corresponding to or correlated with the injected fuel quantity estimate.

In some embodiments, operation of the gaseous fueling system using the injected fuel quantity estimate may include modifying injector control logic using the injected fuel quantity estimate and controlling the gaseous fuel injector using the modified injector control logic. The modification of the injector control logic may include modifying or updating one or more models, one or more tables, and/or one or more equations utilized to determine an injector control command. The injector control command may comprise a commanded injector on time. In some forms, the commanded injector on-time may correspond to a particular or an individual injector. Some forms may include controls configured to determine a commanded injector on time in response to a commanded fuel quantity, a gaseous fuel pressure of a fuel rail, a gaseous fuel pressure of an intake manifold, an engine speed, and a gaseous fuel temperature. Such forms may utilize a multi-dimensional lookup table, an equation with tunable coefficients, or another type of injector control model.

In some embodiments, operation of gaseous fueling system using the injected fuel quantity estimate may include performing a diagnostic of the gaseous fuel injector using the injected fuel quantity estimate. The diagnostic may include determining a present error condition or a future or predicted error condition (e.g., a prognostic) at least in part in response to a difference between an expected fuel quantity (e.g., a commanded fuel quantity) and

From operation 216, process 200 proceeds to operation 299 at which process 200 ends and may be thereafter be repeated or reinitiated.

Process 200 is one example of a process of operating a gaseous fueling system including a fuel rail in fluid communication with a gaseous fuel injector and a combustion chamber in fluid communication with the gaseous fuel injector. Process 200 may performed to obtain an injection quantity estimate for one or more or for all injection events during a given duration of engine operation in a manner that is unobtrusive and does not require interruption of otherwise commanded injection or engine operation. Process 200 also provides one example of calculating an injected quantity estimate based on measuring the magnitude of the change in supply pressure following an injection event which can be used for a number of operations including: individual injector closed loop injection quantity control, injector injected quantity balancing, injector diagnostics and prognostics.

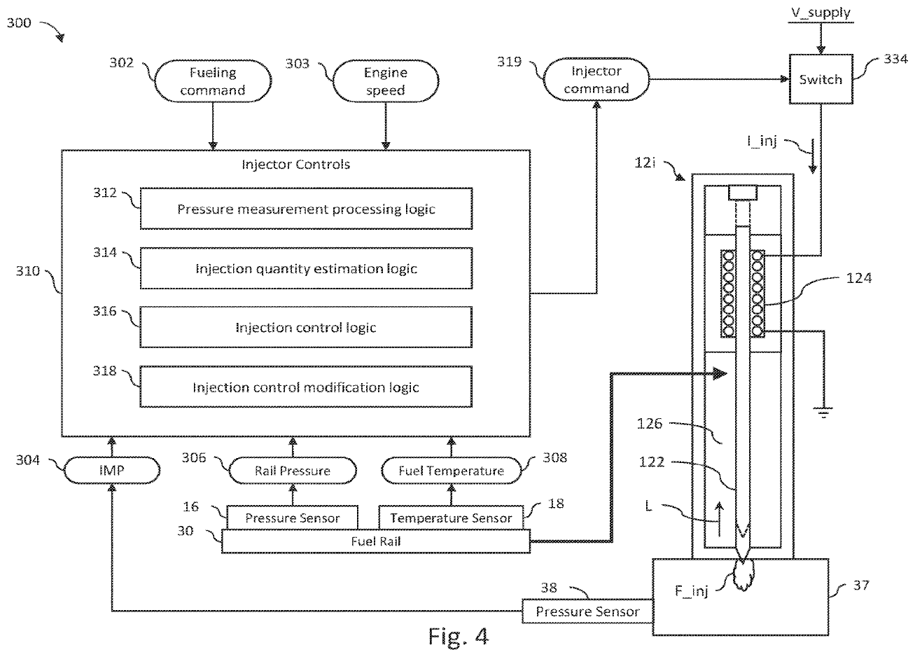

With reference to FIG. 4, there are illustrated example controls 300 which may be implemented in and operated by one or more components of an electronic control system such as ECS 20 or another electronic control system configured for operative communication with a fueling system. In some forms, at least a portion of controls 300 may be implemented in one or mode electronic control units of an electronic control system such as ECU 22 or additional or alternative electronic control units.

Controls 300 include injector controls 310 which are configured to determine and output at least one injector control signal 319 to control operation of an injector 12i in response to one or more inputs. In the illustrated example, injector controls 310 are configured to determine and output injector commands for a particular individual injector 12i. Controls 300 may include additional instances of injector controls the same as or similar to injector controls 310 which are configured to determine and output injector commands for other particular individual injectors.

In the illustrated example, injector controls 310 are configured to receive a plurality of inputs including fueling command 302, engine speed 303, intake manifold pressure (IMP) 304, rail pressure 306, and rail temperature 308. In other embodiments, injector controls 310 may be configured to receive additional or alternative inputs.

Fueling command 302 may include a fueling quantity (Q) and a fueling pressure (P). Fueling command 302 may be determined and provided to injector controls 310 in response to an operator input such as an accelerator pedal position or in response to automated operation of an electronic control system such as an adaptive cruise control system. Engine speed 303 may be provided by an engine speed sensor. Engine speed 303 may be provided to injector controls 310 via a dedicated connection or via one or more communication networks.

IMP 304 may be provided by pressure sensor 38 which is in operative communication with and configured to sense a pressure of intake manifold 37. IMP 304 may be provided to injector controls 310 via a dedicated connection or via one or more communication networks. IMP 304 may be utilized as a pressure of an intake manifold described above in connection with process 200 or may be utilized in determining the pressure of the intake manifold.

Rail pressure 306 may be provided by pressure sensor 16 which is in operative communication with and configured to sense a pressure of fuel rail 30 which is configured to supply fuel to injector 12i and may also be configured to supply fuel to other injectors. Rail pressure 306 may be provided to injector controls 310 via a dedicated connection or via one or more communication networks. Rail pressure 306 may be utilized as a rail pressure measurement described above in connection with process 200 and may be sampled repeatedly to determine multiple points or values of a rail pressure measurement.

Rail temperature 308 may be provided by temperature sensor 18 which is in operative communication with and configured to sense a temperature of fuel rail 30. Rail temperature 308 may be provided to injector controls 310 via a dedicated connection or via one or more communication networks. Rail temperature 308 may be utilized as a rail temperature described above in connection with process 200 and may be sampled repeatedly to determine multiple points or values of a rail temperature measurement.

Injector controls 310 comprise control circuitry configured to implement and execute control logic for processing the inputs received by injector controls 310 and to determine and output injector control signal 319. In the illustrated example the circuitry of injector controls 310 is configured to provide and execute pressure measurement processing logic 312, injection quantity estimation logic 314, injection control logic 316, and injection control modification logic 318. In other embodiments, the control logic provided by injector controls 310 may be differently organized with the aspects of one or more of the illustrated logic blocks being combined in a single block or units, divided into multiple blocks or units, and/or provided with additional or alternative blocks or units.

In the illustrated example, pressure measurement processing logic 312 and injection quantity estimation logic 314 are configured to implement and execute one or more operations of a process such as process 200 described above in connection with FIG. 3. Pressure measurement processing logic 312 is configured to perform a plurality of operations relating to the receipt and processing of a rail pressure 306 such as, for example, operation 206, operation 208, and operation 210 of process 200. Injection quantity estimation logic 314 is configured to perform a plurality of operations relating to calculation of an injected fuel quantity estimate using the output of pressure measurement processing logic 312 such as, for example, operation 212, operation 214, and operation 214 of process 200. In other embodiments, the foregoing operations may be differently distributed between or among pressure measurement processing logic 312, injection quantity estimation logic 314, and/or additional logic injector controls 310.

Injection control logic 316, is configured to determine injector commands to provide output including injector control signal 319. Injector control logic 316 may be configured to determine an injector on-time command effective to set injector control signal 319 to an injector-on state or value for a duration corresponding to a commanded injector on time. Injector control logic 316 may determine the injector on-time command in response to fueling command 302, engine speed 303, and intake manifold pressure (IMP) 304, rail pressure 306, and rail temperature 308 and may utilize a number of techniques to perform this determination.

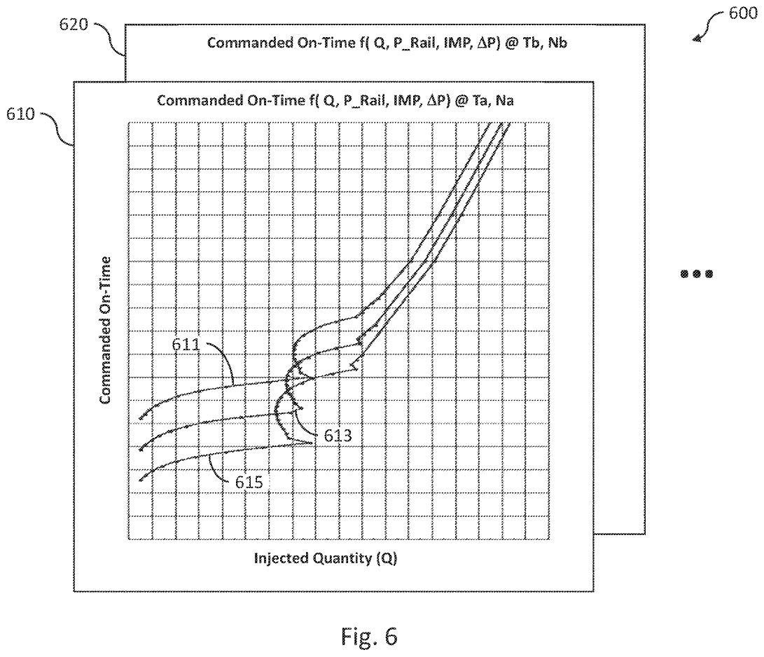

In some embodiments, injector control logic 316 may be configured and provided as one or more lookup tables, maps or response surfaces which are configured and operable to provide an injector on-time command in response to the aforementioned inputs. FIG. 6 illustrates an example set of tables 600 according to which injector control logic 316 may be configured to determine an injector on-time commanded for a give input values of engine speed 303, intake manifold pressure (IMP) 304, rail pressure 306, and rail temperature 308.

Table 610 defines several relationships between commanded on-time as a function of injection quantity at a first gaseous fuel temperature (Ta) and a first engine speed (Na). Curve 611 depicts this functional relationship for first values of rail pressure (P_rail) and intake manifold pressure (EMIP). Curve 613 and curve 615 depict this functional relationship for second and third values, respectively, of P_rail and EVIP. It shall be appreciated that table 610 may include additional curves depicting this functional relationship for different values of P_rail and IMP. Table 620 defines several other relationships between commanded on-time as a function of injection quantity at a second gaseous fuel temperature (Tb) and a second engine speed (Nb).

It shall be appreciated that additional tables for combinations of other gaseous fuel temperatures and engine speeds may also be provided in the set of tables 600. It shall also be appreciated that interpolation between a set of two or more tables, between a set of two or more curves of a given table may be utilized to determine intermediate values.

In some embodiments, injector control logic 316 may be configured and operable to solve one or more equations to determine an injector on-time command in response to the aforementioned inputs. Equation (1) provides an example of an equation which may be so utilized:

$$t = \frac{{Q}_{Tref} - {C}_{0} + {C}_{1} {P}_{S} + {C}_{2} {P}_{d} + {C}_{3} {P}_{s}^{2} + {C}_{4} {P}_{d}^{2} + {C}_{5} {P}_{s} {P}_{d}}{{C}_{6} + {C}_{7} {P}_{s}} \qquad ( 1 )$$

Wherein t is the commanded injector on time, Q_{T ref} is injection quantity at a defined reference temperature, Pₛ is the pressure of gaseous at the fuel rail, P_{d} is the intake manifold pressure, and C₀, C₁, C₂, C₃, C₄, C₅, C₆, and C₇ are coefficients which may be empirically determined or derived from a physics based model and which may be tuned to vary the effect of equation (1).

The injector-on state of injector control signal 319 may be effective to actuate switch 334. Switch 334 is operatively coupled with a system voltage source (V_supply) and configured to selectably supply an injector current (I_inj) a solenoid 124 of an injector 12. The injector current (I_inj) is effective to energize solenoid 124 to induce lifting motion of injector armature 122 (sometimes referred to as an injector needle) in the direction generally indicated by arrow L. In the lifted position (illustrated in phantom as denoted by dashed lines), injector armature 122 allows fuel supplied to injector gallery 126 to exit one or more apertures of a tip of injector 12 as an fuel injection (F_inj) into a port of intake manifold 37 leading to an associated combustion chamber of engine 10.

Injection control modification logic 318 is configured to modify a relationship between an injector on-time command and a commanded injection quantity which is utilized by injector control logic 316 as described above. In some embodiment injection control modification logic 318 may be configured to modify one or more tables defining one or more relationships between commanded on-time as a function of injection quantity at a given gaseous fuel temperature and a given engine speed such as described above in connection with injector control logic 316. In some embodiment injection control modification logic 318 may be configured to modify one or more coefficients of an equation defining one or more relationships between commanded on-time as a function of injection quantity at a given gaseous fuel temperature and a given engine speed such as described above in connection with injector control logic 316. In some embodiments injection control modification logic 318 may be configured to modify one values in adaptive tables defining one or more relationships between commanded on-time as a function of injection quantity at a given gaseous fuel temperature and a given engine speed such as described above in connection with injector control logic 316.

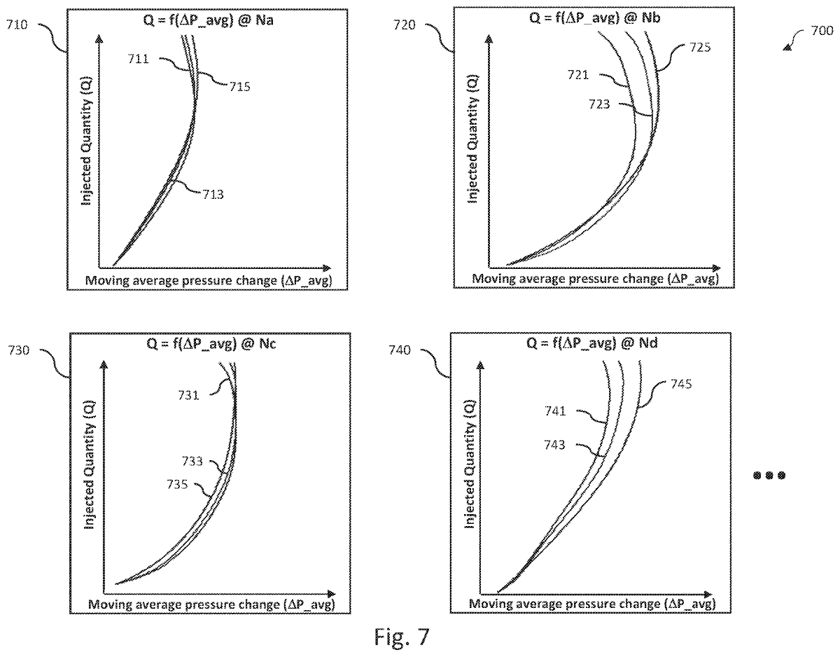

Injection control modification logic 318 may modify one or more of the foregoing relationships between an injector on-time command and a commanded injection quantity by comparing a calculated injected fuel quantity estimate, such as the estimate determined in operation 214 of process 200, with an existing model of the relationship. The existing model of the relationship may comprise a set of look-up tables. FIG. 7 illustrates an example set of look-up tables 700 which may be utilized by injection quantity estimation logic 314.

Set of look-up tables 700 includes table 710, table 720, table 730, and table 740. Table 710 defines several relationships between an injected quantity (Q) as a function of a filtered, moving average pressure change (AP_avg) at first engine speed (Na). Curve 711 depicts this functional relationship for a first value of rail fuel temperature. Curve 713 and curve 715 depict this functional relationship for second and third values, respectively, rail fuel temperature. It shall be appreciated that table 710 may include additional curves depicting this functional relationship for different values of the rail fuel temperature.

Table 720 defines additional relationships between commanded on-time as a function of injection quantity at a second engine speed (Nb) which are denoted by curves 721, 723, and 725 which correspond to the first, second, and third values of fuel rail temperature, respectively. Table 730 defines additional relationships between commanded on-time as a function of injection quantity at a third engine speed (Nc) which are denoted by curves 731, 733, and 735 which correspond to the first, second, and third values of fuel rail temperature, respectively. Table 740 defines additional relationships between commanded on-time as a function of injection quantity at a fourth engine speed (Nd) which are denoted by curves 741, 743, and 745 which correspond to the first, second, and third values of fuel rail temperature, respectively.

Injection control modification logic 318 may compare a calculated injected fuel quantity estimate with a predicted injected quantity for an engine speed and fuel rail temperature corresponding to one of tables 710, 720, 730, 740, for example, by determining a difference between the calculated injected fuel quantity estimate and the predicted injected quantity. The comparison of difference may be utilized to modify the relationship between an injected quantity (Q) and a moving average pressure change (AP_avg) at given engine speed and fuel rail temperature. The relationship between an injected quantity (Q) and a moving average pressure change (AP_avg) at given engine speed and fuel rail temperature may be a part of injection quantity estimation logic used 314 to estimate the injected quantity. A comparison of difference between the commanded injected quantity and the estimated injected quantity may be utilized to modify the relationship or relationships which are used to determine the commanded on-time for an injected quantity (Q) as a function of characteristics of variables such as the rail pressure, the intake manifold pressure, the engine speed, the fuel temperature, and the operating gaseous fuel. In some embodiments, the modified relationship may be incorporated into or utilized to modify one or more of the set of tables 600 utilized by injector control logic 316. In some embodiments, the modified relationship may be incorporated into or utilized to modify one or more coefficients of an equation utilized by injector control logic 316.

It shall be appreciated that additional tables for combinations of other gaseous fuel temperatures and engine speeds may also be provided in the set of tables 700. It shall also be appreciated that interpolation between a set of two or more tables, between a set of two or more curves of a given table may be utilized to determine intermediate values.

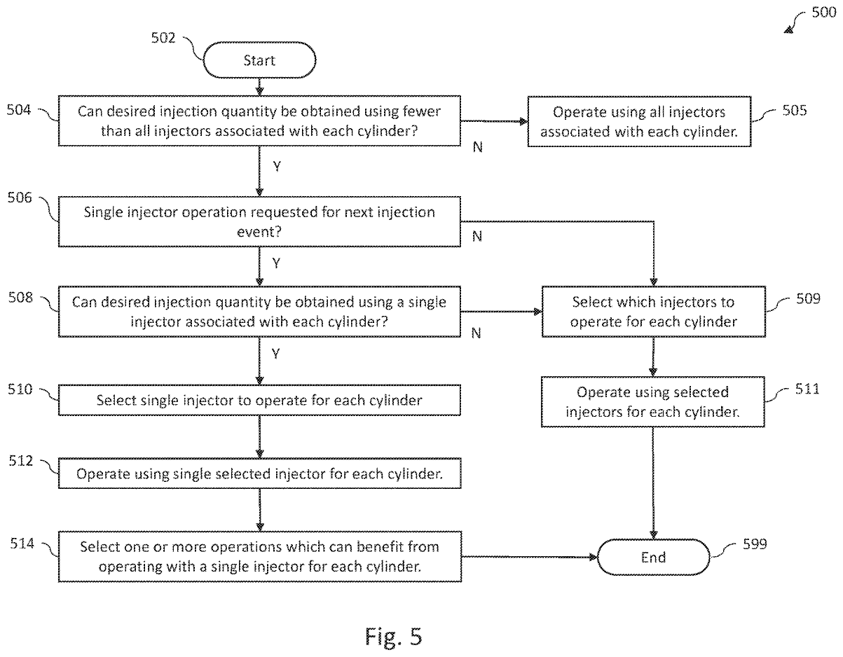

With reference to FIG. 5, there is illustrated a flow diagram depicting certain aspects of an example process 500 for operating an electronic control system (e.g., ECS 20 or another electronic control system), in operative communication with a fueling system (e.g., gaseous fueling system 9 or another fueling system). Process 500 may be implemented in and performed by one or more components of an electronic control system such as one or more electronic control units (e.g., ECU 22 and/or other electronic control units) and/or by other electronic control system components.

Process 500 is adapted to be implemented and performed in connection with a system in which a plurality of cylinders may be supplied with gaseous fuel from either or both of two or more gaseous fuel injectors, such as the example embodiment illustrated in FIG. 2 in which a first plurality of gaseous fuel injectors (e.g., injectors 12f) comprise a first plurality of first pairs of gaseous fuel injectors each configured to supply fuel to a respective one of a first set of cylinders (e.g., cylinders 130f), and a second plurality of gaseous fuel injectors (e.g., injectors 12r) comprise a second plurality of second pairs of gaseous fuel injectors each configured to supply fuel to a respective one of a second set of cylinders (e.g., cylinders 13r).

Process 500 begins at start operation 502 and proceeds to conditional 504 which evaluates whether the operational state of an associated engine system and/or gaseous fueling system is such that a desired injection quantity (e.g., a commanded injection quantity) can be obtained using less than the full number of injectors associated with each cylinder. Conditional 504 may perform this evaluation by evaluating or determining whether a commanded fuel quantity can be delivered by less than the total number of injectors associated with each cylinder. If conditional 504 evaluates negative, process 500 proceeds to operation 505 which operate the system using the full number of injectors associated with each cylinder.

If conditional 504 evaluates affirmative, process 500 proceeds to conditional 506 evaluates whether single injector operation is requested for that the next injection event should operate with less than the full number of injectors associated with each cylinder (e.g., injection performed by only one of two injectors servicing a particular cylinder or by less than the total number of injectors servicing a particular cylinder). Operation 506 may make this determination based upon a request to check for potential modification of gaseous fuel injection control processes and/or controls such as those described in connection with FIGS. 2 and 3. Such request may be provided periodically or at other spaced apart times to perform an updating or optimization of the operation of one or more gaseous fuel injectors.

If conditional 506 evaluates negative, process 500 proceeds to operation 509 which selects two or more injectors but less than the total number of injectors to operate for each cylinder. This selection may be configured to balance a total number of injections performed by the injectors servicing each cylinder, for example, by alternating or cycling through which injectors are selected in a predetermined order or based upon an operation count associated with each injector. This selection may be configured to limit the use of any injector which system diagnostics and/or prognostics has/have identified as potentially operating in an unexpected or abnormal manner. From operation 509, process 500 proceeds to operation 511 which operates the engine using the injectors selected for each cylinder at operation 509. From operation 511, process 500 proceeds to end operation 599 and may thereafter repeat.

If conditional 506 evaluates affirmative, process 500 proceeds to conditional 508 which evaluates whether a desired injection quantity (e.g., a commanded injection quantity) can be obtained using a single injector associated with each cylinder. If conditional 508 evaluates negative, process 500 proceeds to operation 511 and further proceeds as described above.

If conditional 508 evaluates affirmative, process 500 proceeds to operation 510 which selects an injector to operate for each cylinder. This selection may be configured to balance a total number of injections performed by the injectors servicing each cylinder, for example, by alternating or cycling through which injectors are selected in a predetermined order or based upon an operation count associated with each injector.

From operation 510, process 500 proceeds to operation 512 which operates the engine using the single injector selected for cylinder at operation 510. From operation 512, process 500 proceeds to operation 512 which select one or more operations which can benefit from operating with a single injector for each cylinder.

From operation 506, process 500 proceeds to conditional 508 which evaluates whether the controls associated with process 500 command operation with less than the full number of injectors associated with each cylinder. If conditional 508 evaluates negative, process 500 proceeds to operation 505 which operate the system using the full number of injectors associated with each cylinder. From operation 514, process 500 proceeds to end operation 599 and may thereafter repeat.

Operation 514 may select a number of processes or algorithms which can benefits from operating with a single injector for each cylinder. Some such processes improve injection quantity accuracy such as by updating an injector controls described above in connection with FIGS. 2 and 3. Some such processes improve balancing of the injected quantity for the operational injectors. Some such processes improve diagnostic and prognostics for the operational injector, for example, based on an improved estimate of injection quantity. Some such processes reduce in the total electrical power of the drivers to the injectors. Some such processes improve improved capability to measure injection characteristics with the single operational injector. Some such processes improve the capability to compare the injection characteristics and their effects on the engine for the multiple injectors associated with each. Some such processes improve system robustness by enabling continued engine operation despite injector failures.

As shown by this detailed description, the present disclosure contemplates multiple and various embodiments, including, without limitation, the following example embodiments. A first example embodiment is a process of operating a gaseous fueling system including a fuel rail in fluid communication with a gaseous fuel injector and a combustion chamber in fluid communication with the gaseous fuel injector, the process comprising: operating the gaseous fuel injector perform an injection of gaseous fuel to the combustion chamber; obtaining a pressure measurement indicating a pressure of gaseous fuel in the rail during the operating; determining an upper value of the pressure measurement and a lower value of the pressure measurement; calculating a difference between the upper value of the pressure measurement and the lower value of the pressure measurement; calculating an injected fuel quantity estimate using the difference; and operating the gaseous fueling system using the injected fuel quantity estimate.

A second example embodiment includes the features of the first example embodiment, wherein the operating the gaseous fueling system using the injected fuel quantity estimate comprises modifying injector control logic using the injected fuel quantity estimate and controlling the gaseous fuel injector using the modified injector control logic.

A third example embodiment includes the features of the first example embodiment, wherein the operating the gaseous fueling system using the injected fuel quantity estimate comprises performing a diagnostic of the gaseous fuel injector using the injected fuel quantity estimate.

A fourth example embodiment includes the features of the first example embodiment, wherein the operating the gaseous fueling system using the injected fuel quantity estimate comprises balancing operation of the gaseous fuel injector with operation of a second gaseous fuel injector of the gaseous fueling system.

A fifth example embodiment includes the features of the first example embodiment, and comprises filtering the pressure measurement after the obtaining and prior to the determining.

A sixth example embodiment includes the features of the first example embodiment, wherein the calculating the estimate of the injected quantity uses an engine speed, and a temperature of gaseous fuel in the rail during the operating.

A seventh example embodiment includes the features of the first example embodiment, and comprises evaluating whether to operate less than a total number of gaseous fuel injectors associated with each of a plurality of combustion chambers, wherein in response to the evaluating the operating the gaseous fuel injector comprises operating less than the total number of gaseous fuel injectors associated with the combustion chamber.

An eighth example embodiment includes the features of the first example embodiment, and comprises evaluating whether to operate a single one of multiple gaseous fuel injectors associated with each of a plurality of combustion chambers, wherein in response to the evaluating the operating the gaseous fuel injector comprises operating the single one of the multiple gaseous fuel injectors associated with the combustion chamber.

A ninth example embodiment is a system comprising: an electronic control system in operative communication with a gaseous fueling system including a fuel rail in fluid communication with a gaseous fuel injector and a combustion chamber in fluid communication with the gaseous fuel injector, the electronic control system being configured to: operate the gaseous fuel injector perform an injection of gaseous fuel to the combustion chamber; obtain a pressure measurement indicative of pressure of gaseous fuel in the rail during operation of the gaseous fuel injector to perform the injection; determine an upper value of the pressure measurement and a lower value of the pressure measurement; calculate a difference between the upper value of the pressure measurement and the lower value of the pressure measurement; calculate an injected fuel quantity estimate using the difference; and operate the gaseous fueling system using the injected fuel quantity estimate.

A tenth example embodiment includes the features of the ninth example embodiment, wherein the electronic control system being configured to operate the gaseous fueling system using the injected fuel quantity estimate comprises the electronic control system being configured to modify injector control logic using the injected fuel quantity estimate and control the gaseous fuel injector using the modified injector control logic.

An eleventh example embodiment includes the features of the ninth example embodiment, wherein the electronic control system being configured to operate the gaseous fueling system using the injected fuel quantity estimate comprises the electronic control system being configured to perform a diagnostic of the gaseous fuel injector using the injected fuel quantity estimate.

A twelfth example embodiment includes the features of the ninth example embodiment, wherein the electronic control system being configured to operate the gaseous fueling system using the injected fuel quantity estimate comprises the electronic control system being configured to balance operation of the gaseous fuel injector with operation of a second gaseous fuel injector of the gaseous fueling system.

A thirteenth example embodiment includes the features of the ninth example embodiment, wherein the electronic control system is configured to filter the pressure measurement and determine the upper value of the pressure measurement and the lower value of the pressure measurement using the filtered pressure measurement.

A fourteenth example embodiment includes the features of the ninth example embodiment, wherein the electronic control system being configured to calculate the estimate of the injected quantity uses an engine speed, and a temperature of gaseous fuel in the rail during the operating.

A fifteenth example embodiment is a system comprising: an internal combustion engine including plurality of cylinders arranged in an in-line configuration; a first fuel rail configured to received gaseous fuel from a gaseous fuel source and to provide gaseous fuel to a first plurality of gaseous fuel injectors; and a second fuel configured to received gaseous fuel from the gaseous fuel source and to provide gaseous fuel to a second plurality of gaseous fuel injectors, the second fuel rail being at least one of physically separated and divided from the first fuel rail; wherein the first plurality of gaseous fuel injectors are configured to inject fuel to a first subset of the plurality of cylinders and the second plurality of gaseous fuel injectors are configured to inject fuel to a second subset of the plurality of cylinders.

A sixteenth example embodiment includes the features of the fifteenth example embodiment, wherein the first subset of the plurality of cylinders and the second subset of the plurality of cylinders are selected and configured such that a firing order of the plurality of cylinders alternates between the first subset and the second subset.

A seventeenth example embodiment includes the features of the fifteenth example embodiment, wherein the first subset of the plurality of cylinders and the second subset of the plurality of cylinders are selected and configured such that neither the first subset nor the second subset include adjacent cylinders firing in sequence in a firing order of the plurality of cylinders.

An eighteenth example embodiment includes the features of the fifteenth example embodiment, wherein the internal combustion engine is an in-line six-cylinder engine, the plurality of cylinders are arranged in an in-line order including a cylinder number one, a cylinder number two, a cylinder number three, a cylinder number four, a cylinder number five, and a cylinder number six, and a firing order of the plurality of cylinders is cylinder number one followed by cylinder number five, followed by cylinder number three, followed by cylinder number six, followed by cylinder number two, followed by cylinder number four.

A nineteenth example embodiment includes the features of the fifteenth example embodiment, wherein the first plurality of gaseous fuel injectors comprise a first plurality of first pairs of gaseous fuel injectors each configured to supply fuel to a respective one of a first set of cylinders, and the second plurality of gaseous fuel injectors comprise a second plurality of second pairs of gaseous fuel injectors each configured to supply fuel to a respective one of a second set of cylinders.

A twentieth example embodiment includes the features of the fifteenth example embodiment, wherein the first fuel rail is a front fuel rail, the second fuel rail is a rear fuel rail having a relative positioning on the internal combustion engine rearward of the front fuel rail, and the second subset of the plurality of cylinders having a relative positioning on the internal combustion engine rearward of first subset of the plurality of cylinders.

A twenty-first example embodiment is a process of operating a gaseous fueling system including a fuel rail in fluid communication with a gaseous fuel injector and a combustion chamber in fluid communication with the gaseous fuel injector, the process comprising: evaluating whether to operate a single one of multiple gaseous fuel injectors associated with each of a plurality of combustion chambers; in response to the evaluating, operating the single one of a total number of gaseous fuel injectors associated with the combustion chamber; and performing a control operation requiring single-injector operation in response to the operating.

A twenty-second example embodiment includes the features of the tenth-first example embodiment, wherein a control operation requiring single-injector operation comprises calculating an injected fuel quantity estimate.

A twenty-third example embodiment includes the features of the twenty-second example embodiment, wherein the control operation requiring single-injector operation comprises: obtaining pressure measurements indicating a pressure of gaseous fuel in the rail during the operating; determining an upper value of the pressure measurement and a lower value of the pressure measurement; calculating a difference between the upper value of the pressure measurement and the lower value of the pressure measurement; calculating the injected fuel quantity estimate using the difference; and operating the gaseous fueling system using the injected fuel quantity estimate.

A twenty-fourth example embodiment includes the features of the twenty-third example embodiment, wherein the operating the gaseous fueling system using the injected fuel quantity estimate comprises modifying injector control logic using the injected fuel quantity estimate and controlling the gaseous fuel injector using the modified injector control logic.

A twenty-fifth example embodiment includes the features of the twenty-third example embodiment, wherein the operating the gaseous fueling system using the injected fuel quantity estimate comprises performing a diagnostic of the gaseous fuel injector using the injected fuel quantity estimate.

A twenty-sixth example embodiment includes the features of the twenty-third example embodiment, wherein the operating the gaseous fueling system using the injected fuel quantity estimate comprises balancing operation of the gaseous fuel injector with operation of a second gaseous fuel injector of the gaseous fueling system.

A twenty-seventh example embodiment includes the features of the twenty-first example embodiment, and comprises prior to the evaluating whether to operate the single one of multiple gaseous fuel injectors, first evaluating whether to operate less than a total number of gaseous fuel injectors associated with each of a plurality of combustion chambers; and in response to the evaluating and the first evaluating, one of: operating the single one of the total number of gaseous fuel injectors, and operating more than the single one of the total number of gaseous fuel injectors, but less than the total number of gaseous fuel injectors associated with each of the plurality of combustion chambers.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to any of a number of acts, configurations, devices, operations, and techniques, individually or in combination, including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A process of operating a gaseous fueling system including a fuel rail in fluid communication with a gaseous fuel injector and a combustion chamber in fluid communication with the gaseous fuel injector, the process comprising:
operating the gaseous fuel injector perform an injection of gaseous fuel to the combustion chamber;
obtaining a pressure measurement indicating a pressure of gaseous fuel in the rail during the operating;
determining an upper value of the pressure measurement and a lower value of the pressure measurement;
calculating a difference between the upper value of the pressure measurement and the lower value of the pressure measurement;
calculating an injected fuel quantity estimate using the difference; and
operating the gaseous fueling system using the injected fuel quantity estimate.

2. The process of claim 1, wherein the operating the gaseous fueling system using the injected fuel quantity estimate comprises modifying injector control logic using the injected fuel quantity estimate and controlling the gaseous fuel injector using the modified injector control logic.

3. The process of claim 1, wherein the operating the gaseous fueling system using the injected fuel quantity estimate comprises performing a diagnostic of the gaseous fuel injector using the injected fuel quantity estimate.

4. The process of claim 1, wherein the operating the gaseous fueling system using the injected fuel quantity estimate comprises balancing operation of the gaseous fuel injector with operation of a second gaseous fuel injector of the gaseous fueling system.

5. The process of claim 1, comprising filtering the pressure measurement after the obtaining and prior to the determining.

6. The process of claim 1, wherein the calculating the estimate of the injected quantity uses an engine speed, and a temperature of gaseous fuel in the rail during the operating.

7. The process of claim 1, comprising evaluating whether to operate less than a total number of gaseous fuel injectors associated with each of a plurality of combustion chambers, wherein in response to the evaluating the operating the gaseous fuel injector comprises operating less than the total number of gaseous fuel injectors associated with the combustion chamber.

8. The process of claim 1, comprising evaluating whether to operate a single one of multiple gaseous fuel injectors associated with each of a plurality of combustion chambers, wherein in response to the evaluating the operating the gaseous fuel injector comprises operating the single one of the multiple gaseous fuel injectors associated with the combustion chamber.

9. A system comprising:
an electronic control system in operative communication with a gaseous fueling system including a fuel rail in fluid communication with a gaseous fuel injector and a combustion chamber in fluid communication with the gaseous fuel injector, the electronic control system being configured to:
operate the gaseous fuel injector perform an injection of gaseous fuel to the combustion chamber;
obtain a pressure measurement indicative of pressure of gaseous fuel in the rail during operation of the gaseous fuel injector to perform the injection;
determine an upper value of the pressure measurement and a lower value of the pressure measurement;
calculate a difference between the upper value of the pressure measurement and the lower value of the pressure measurement;
calculate an injected fuel quantity estimate using the difference; and
operate the gaseous fueling system using the injected fuel quantity estimate.

10. The system of claim 9, wherein the electronic control system being configured to operate the gaseous fueling system using the injected fuel quantity estimate comprises the electronic control system being configured to modify injector control logic using the injected fuel quantity estimate and control the gaseous fuel injector using the modified injector control logic.

11. The system of claim 9, wherein the electronic control system being configured to operate the gaseous fueling system using the injected fuel quantity estimate comprises the electronic control system being configured to perform a diagnostic of the gaseous fuel injector using the injected fuel quantity estimate.

12. The system of claim 9, wherein the electronic control system being configured to operate the gaseous fueling system using the injected fuel quantity estimate comprises the electronic control system being configured to balance operation of the gaseous fuel injector with operation of a second gaseous fuel injector of the gaseous fueling system.

13. The system of claim 9, wherein the electronic control system is configured to filter the pressure measurement and determine the upper value of the pressure measurement and the lower value of the pressure measurement using the filtered pressure measurement.

14. The system of claim 9, wherein the electronic control system being configured to calculate the estimate of the injected quantity uses an engine speed, and a temperature of gaseous fuel in the rail during the operating.

15. A system comprising:
an internal combustion engine including plurality of cylinders arranged in an in-line configuration;
a first fuel rail configured to received gaseous fuel from a gaseous fuel source and to provide gaseous fuel to a first plurality of gaseous fuel injectors; and
a second fuel configured to received gaseous fuel from the gaseous fuel source and to provide gaseous fuel to a second plurality of gaseous fuel injectors, the second fuel rail being at least one of physically separated and divided from the first fuel rail;
wherein the first plurality of gaseous fuel injectors are configured to inject fuel to a first subset of the plurality of cylinders and the second plurality of gaseous fuel injectors are configured to inject fuel to a second subset of the plurality of cylinders.

16. The system of claim 15, wherein the first subset of the plurality of cylinders and the second subset of the plurality of cylinders are selected and configured such that a firing order of the plurality of cylinders alternates between the first subset and the second subset.

17. The system of claim 15, wherein the first subset of the plurality of cylinders and the second subset of the plurality of cylinders are selected and configured such that neither the first subset nor the second subset include adjacent cylinders firing in sequence in a firing order of the plurality of cylinders.

18. The system of claim 15, wherein the internal combustion engine is an in-line six-cylinder engine, the plurality of cylinders are arranged in an in-line order including a cylinder number one, a cylinder number two, a cylinder number three, a cylinder number four, a cylinder number five, and a cylinder number six, and a firing order of the plurality of cylinders is cylinder number one followed by cylinder number five, followed by cylinder number three, followed by cylinder number six, followed by cylinder number two, followed by cylinder number four.

19. The system of claim 15, wherein the first plurality of gaseous fuel injectors comprise a first plurality of first pairs of gaseous fuel injectors each configured to supply fuel to a respective one of a first set of cylinders, and the second plurality of gaseous fuel injectors comprise a second plurality of second pairs of gaseous fuel injectors each configured to supply fuel to a respective one of a second set of cylinders.

20. The system of claim 15, wherein the first fuel rail is a front fuel rail, the second fuel rail is a rear fuel rail having a relative positioning on the internal combustion engine rearward of the front fuel rail, and the second subset of the plurality of cylinders having a relative positioning on the internal combustion engine rearward of first subset of the plurality of cylinders.

21.-27. (canceled)
